(19) United States
(12) Patent Application Publication
(10) Pub. No.: US 2026/0086503 A1
(43) Pub. Date: Mar. 26, 2026

(54) NON-MAGNETIC PIVOT AXIS

(71) Applicant: Nivarox-FAR S.A., Le Locle (CH)

(72) Inventors: Lionel MICHELET, Sainte-Croix (CH); Christian CHARBON, Chézard-St-Martin (CH); Marco VERARDO, Les Bois (CH)

(73) Assignee: Nivarox-FAR S.A., Le Locle (CH)

(21) Appl. No.: 19/299,656

(22) Filed: Aug. 14, 2025

(30) Foreign Application Priority Data
Sep. 26, 2024 (EP) 24203032.8

(51) Int. Cl. G04B 31/012; C22C 27/04; C23C 8/20; G04B 31/06; G04D 3/00

(52) U.S. Cl. CPC G04B 31/012; C22C 27/04; C23C 8/20; G04B 31/06; G04D 3/0097

(57) ABSTRACT

A pivot axis for a horology movement, including at least a part made of pure tungsten or of a tungsten alloy with at least a portion of the part converted into a layer of tungsten carbide (5).

### CROSS-REFERENCE TO RELATED APPLICATIONS

This application claims priority to European Patent Application No. 24203032.8 filed on Sep. 26, 2024, the entire contents of which are incorporated herein by reference.

### Technical Field of the Invention

The present invention relates to a non-magnetic pivot axis for a mechanical horology movement and more specifically to a balance staff.

### Technological Background

The manufacture of a horology pivot axis consists of using a hardenable steel bar to carry out profile turning operations to define various active surfaces (shoulder, shouldering, pivots, etc.) then subjecting the profile-turned axis to thermal treatment operations comprising at least one hardening operation to improve the hardness of the axis and one or more tempering operations to improve its tenacity. The thermal treatment operations are followed by a burnishing operation on the axis pivots, which consists of polishing the pivots to the required dimensions. During the burnishing operation, the hardness and roughness of the pivots are further improved.

The pivot axes, for example balance staffs conventionally used in mechanical horology movements, are made from profile turning steel grades which are generally martensitic carbon steels including lead and manganese sulphides to improve their machinability. A steel of this type, called 20AP, is typically used for these applications.

The advantage of this type of material is that it is easily machined, in particular because it is suitable for profile turning and, after hardening and tempering treatments, has superior mechanical properties that are highly attractive for the production of horology pivot axes. In particular, after thermal treatment, these steels have a high level of hardness, offering very good shock resistance. Typically, the hardness of the pivots on a 20 AP steel axis can reach a value above 700 HV after thermal treatment and burnishing.

Although they provide satisfactory mechanical properties for the horology applications described above, this type of material has the drawback of being magnetic and of being able to disrupt the rate of a watch after being subjected to a magnetic field, particularly when this material is used to make a balance staff engaging with a sprung balance made of ferromagnetic material. This phenomenon is well known to the person skilled in the art. It should also be noted that these martensitic steels are also susceptible to corrosion.

To remedy these drawbacks, tungsten alloys are ideal materials due to their non-magnetic properties. However, the intrinsic hardness of this material is on the order of 400-550 HV, with no possibility of using effective hardening mechanisms to improve the properties. This limited hardness can cause problems with the shock resistance of the pivots.

### SUMMARY OF THE INVENTION

The invention aims to remedy the above drawbacks by providing a pivot axis made at least in part from pure tungsten or a tungsten alloy with a surface hardening that meets the shock resistance requirements in the field of horology.

To this end, to achieve hardening, the axis is subjected over at least part of its surface to thermal treatment in a carbon-rich atmosphere so as to react the tungsten of the axis with the carbon of the atmosphere to form a layer of tungsten carbide which has the characteristic of reaching hardnesses above 2,000 HV.

More specifically, the present invention relates to a pivot axis for a horology movement, characterised in that it comprises at least a part made of pure tungsten or of a tungsten alloy with at least a portion of said part converted into a layer of tungsten carbide.

Tungsten and its alloys combine very good corrosion resistance with very low magnetic susceptibility, while the tungsten carbide layer substantially increases the surface hardness of the pivot axes, which is an advantage for the wear and shock-resistance properties of this timepiece, particularly at the pivots.

Other purposes, advantages and characteristics of the invention will become clearer from the following detailed description, with reference to the appended drawings.

### BRIEF DESCRIPTION OF THE FIGURES

FIG. 1 shows a pivot axis.

FIG. 2 shows a partial cross-section of a pivot axis comprising a layer of tungsten carbide according to the invention.

### DETAILED DESCRIPTION OF THE INVENTION

In this description, the term “non-magnetic” material means a paramagnetic or diamagnetic or antiferromagnetic material with a magnetic permeability comprised between 0.99 and 1.01.

An alloy of an element is an alloy containing at least 50% by weight of said element.

The invention relates to a non-magnetic pivot axis for a mechanical horology movement. The invention will be described below in the context of an application to a balance staff 1. Of course, other types of horology pivot axes are also possible, such as horology mobile axes, typically escapement pinions, or even pallet arbors. Parts of this type have body diameters of preferably less than 2 mm, and pivots with diameters of preferably less than 0.2 mm, with a diameter that can be as small as 50μm at the end of the pivot.

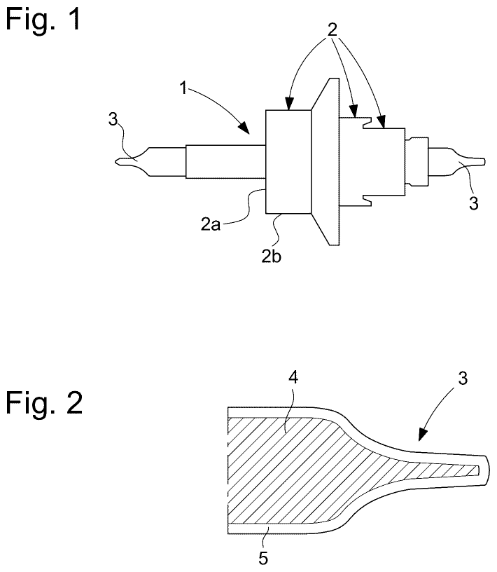

Referring to FIG. 1, a balance staff 1 is shown comprising a plurality of sections 2 with different diameters, preferably formed by profile turning or any other machining technique involving chip removal, and conventionally defining shoulders 2a and shouldering 2b arranged between two end portions defining two pivots 3. Each of these pivots is intended to pivot in a bearing, typically in a hole in a stone or a ruby.

According to the invention, at least part of the pivot axis and in particular at least the part of the axis intended to come into rotational contact with another part is made of pure tungsten or of a tungsten alloy. Also according to the invention, this part or a portion of this part made of pure tungsten or tungsten alloy is covered with a layer of tungsten carbide which can be WC, W2C or a non-stoichiometric WC₍₁₋ₓ₎ carbide.

In the example shown, at least part of the balance staff 1, namely the pivot 3, is made of pure tungsten or a tungsten alloy and at least a portion of this part is converted into a layer of tungsten carbide 5 (FIG. 2). A core 4 made of pure tungsten or a tungsten alloy with a layer of tungsten carbide 5 can be seen.

“Pure tungsten” means a material comprising tungsten in a weight percentage greater than or equal to 99.5%, preferably greater than or equal to 99.95%. As an adjunct to obtain 100% by weight, it can comprise optional impurities such as Mo, C, Fe and O. For example, it can comprise a minimum of 99.95% by weight of W, a maximum of 0.020% by weight of Mo and a maximum of 0.030% by weight of other impurities.

By way of example, the tungsten alloys can comprise either lanthanum oxide, rhenium, or copper and nickel.

More specifically, the alloy of tungsten with lanthanum oxide, namely La₂O₃, contains the latter in a weight percentage comprised between 0.2 and 2%, preferably between 0.3 and 1.5%, more preferentially between 0.5 and 1%. Advantageously, the alloy consists of tungsten, lanthanum oxide in the aforementioned percentages and any impurities with a total content for the latter of less than or equal to 1.5% by weight.

More specifically, the alloy of tungsten with rhenium comprises the latter in a weight percentage comprised between 2 and 30%, preferably between 5 and 20%. Advantageously, the alloy consists of tungsten and rhenium in the above percentages and any impurities with a total content for the latter of less than or equal to 1.5% by weight.

More specifically, the tungsten alloy with copper and nickel comprises copper and nickel with a total content by weight for these two elements comprised between 2 and 20%, preferably between 5 and 10%. Advantageously, the alloy consists of tungsten, copper and nickel in the above percentages and any impurities with a total content for the latter of less than or equal to 1.5% by weight. Preferentially, nickel is predominantly present relative to copper. This means that for the copper+nickel combination forming 100%, the percentage of nickel is greater than or equal to 55% and the percentage of copper is less than or equal to 45%.

The tungsten and tungsten alloys according to the invention have a hardness greater than or equal to 500 HV0.05 for the pure tungsten and greater than or equal to 400 HV0.05 for the tungsten alloys. Vickers hardness (HV) is a hardness measured according to the ISO 6507-1:2018 standard. They have a low magnetic susceptibility, typically with values of less than 8×10⁻⁵, preferably 7×10⁻⁵.

According to the invention, at least part of the pivot axis is made of tungsten or its alloy and then subjected to thermal surface treatment to form the tungsten carbide layer. All of said at least part of the pivot axis can be subjected to thermal treatment or only a portion of this part can be subjected to thermal treatment. In this latter case, the portions which are not intended to react to form a tungsten carbide layer are protected, for example, with a ceramic or refractory metal fitting that leaves only the portions to be treated exposed.

The thermal treatment is carried out in a carbon-rich gaseous atmosphere to enable the tungsten and carbon to react and form tungsten carbide. For example, the atmosphere can comprise methane (CH4) and a neutral gas such as argon (Ar). The percentage of methane can be comprised between 5 and 20% by volume; typically it is 10%, with the remainder being argon. The treatment is carried out at a temperature comprised between 1,000° C. and 1,300° C., ideally at 1,150° C., with a plateau of between 5 minutes and 2 hours, ideally 15 minutes, at the target temperature.

The tungsten carbide layer thus obtained has a maximum hardness of between 2,000 and 2,500 HV0.05. Typically, the tungsten carbide layer can have minor fluctuations in hardness along its thickness with values ranging from 2,000 to 2,500 HV0.05.

The thickness of the tungsten carbide layer obtained depends on the treatment time and temperature settings. The settings of 1,150° C. and a 15-minute hold time make it possible to obtain a layer with a thickness of 20-30 microns. Typically, the thickness is generally comprised between 5 and 50 microns, preferably between 20 and 35 microns.

After thermal treatment, the axis can undergo one or more tribofinishing operations to remove the carbon-rich surface layer and/or to improve the surface roughness of the component.

Prior to thermal treatment, the axis is manufactured from an ebauche in the form of a bar. For example, the manufacturing steps (not shown) for an entire axis made of tungsten or a tungsten alloy are as follows:
Providing a bar made of pure tungsten or a tungsten alloy,
Profile turning, preferably by laser ablation, to form the axis,
Burnishing the pivots,
Deburring and polishing.

It should be noted that burnishing can take place after the thermal treatment.

1. A pivot axis for a horology movement, comprising at least a part made of pure tungsten or of a tungsten alloy with at least a portion of said part converted into a layer of tungsten carbide (5).

2. The pivot axis according to claim 1, wherein the tungsten carbide layer (5) has a thickness comprised between 5 and 50 microns, preferably between 20 and 35 microns.

3. The pivot axis according to claim 1, wherein the tungsten carbide layer (5) has a maximum hardness comprised between 2,000 and 2,500 HV0.05.

4. The pivot axis according to claim 1, wherein it is made of pure tungsten with a tungsten content greater than or equal to 99.5%, preferably greater than or equal to 99.95% by weight with the remainder for 100% comprising impurities.

5. The pivot axis according to claim 1, wherein the tungsten alloy is an alloy with lanthanum oxide, an alloy with rhenium or an alloy with copper and nickel.

6. The pivot axis according to claim 5, wherein the alloy of tungsten with lanthanum oxide comprises lanthanum oxide in a weight percentage comprised between 0.2 and 2%, preferably between 0.3 and 1.5%, more preferentially between 0.5 and 1%, and incidental impurities with a total content for said incidental impurities of less than or equal to 1.5% by weight.

7. The pivot axis according to claim 5, wherein the alloy of tungsten with rhenium comprises rhenium in a percentage by weight comprised between 2 and 30%, preferably between 5 and 20%, and incidental impurities with a total content for said incidental impurities of less than or equal to 1.5% by weight.

8. The pivot axis according to claim 5, wherein the alloy of tungsten with copper and nickel comprises copper and nickel in a total percentage by weight comprised between 2 and 20%, preferably between 5 and 10%, and incidental impurities with a total content for said incidental impurities of less than or equal to 1.5% by weight.

9. The pivot axis according to claim 1, wherein it is a balance staff (1) with said part formed by pivots (3) at the ends of the balance staff (1).

10. A thermal treatment method for a pivot axis comprising the following steps:
providing a pivot axis comprising at least a part made of pure tungsten or of a tungsten alloy,
thermal treatment of at least a portion of said part in a carbon-rich gaseous atmosphere at a holding temperature comprised between 1,000° C. and 1,300° C. for a time comprised between 5 minutes and 2 hours.
